(19) United States
(12) Patent Application Publication
(10) Pub. No.: US 2002/0007308 A1
(43) Pub. Date: Jan. 17, 2002

(54) Network based media space sale system and method

(76) Inventors: Peter M. Anderson, Ridgefield, CT (US); D. Scot Kerr, Trumbull, CT (US)

Correspondence Address: PERMAN & GREEN, 425 POST ROAD, FAIRFIELD, CT, 06430, US

(21) Appl. No.: 09/817,488

(22) Filed: Mar. 26, 2001

Related U.S. Application Data
(60) Provisional application No. 60/192,613, filed on Mar. 26, 2000.

(51) Int. Cl. G06F 17/60

(52) U.S. Cl. 705/14

(57) ABSTRACT

A system and method for placing advertisements with media organizations comprising making use of an electronic database; advertisers accessing the database so as to place offers for an advertising campaign in the data base; media users associated with a media organization accessing the database so as to review the offers; the media user accepting or declining the offers; placing orders for advertising specified by the campaign if an offer is accepted; determining when the advertisements have been run; and transferring funds from the advertisers to the media organization when the advertisements have been run. An electronic message such as an electronic affidavit is provided to the advertiser when the advertisement has been run.

This application claims priority under 35 U.S.C. §119(e) from provisional application serial No. 60/192,613 filed on Mar. 26, 2000.

### FIELD OF THE INVENTION

This invention relates to systems and methods for placing advertising. More particularly, it relates to a method and apparatus for an advertiser to execute a media campaign efficiently and cost effectively using a network, and in particular using the Internet.

### BACKGROUND OF THE INVENTION

There are almost 1600 daily newspapers in the United States of America alone. Further, there are countless magazines and other print media in which businesses may desire to place advertisements.

The placing of advertisements in numerous newspapers, magazines and other print media can become a complex and daunting problem for an advertiser. The placing of even a single advertising campaign in numerous markets throughout the country can be difficult and extremely time-consuming. Further, in general, advertising budgets are limited. Many businesses simply do not have the economic capability of paying retail rates for advertising space. Yet another problem is the one of providing the advertising copy to a large number of newspapers. While there are some private networks that can be used to transmit electronic files, such as the AP (Associated Press) network, the cost is high when files are transferred to a large number of newspapers. Finally, it is difficult for an advertiser to obtain verification that an advertisement has been run by the conventional method of a so called “tear sheet” being provided to the advertiser. Someone must monitor the publications, and actually tear the appropriate page out and send it to the advertiser. While there are services that perform this task, it is time consuming and expensive.

Thus, from an advertiser's point of view, there exists a great need for some way in which businesses can determine where advertising space is available that suits their needs, when it becomes available at a discount, for a method of placing the advertisements in an automated fashion, for an easy method of payment for the advertisements placed, and finally for verification that the advertisements have been run.

The difficulties of media organizations, such as newspapers and magazines, are mirror images of those of the advertisers. Very often there is unsold advertising space that represents a loss of revenue opportunity unless a suitable advertiser for that space can be found. This space could be sold at less than full retail rate and still produce very significant revenue. However, it is often difficult to find a suitable customer. The newspaper has sever time constraints in that the space must be sold before the paper is “put to bed” on a particular day.

Another problem that the media have is that ad copy must generally be reviewed for suitability of content. Generally advertisers and the media have had the problem of using facsimile to transmit copy from one place to another. This does not lend itself to a quick and easy evaluation of the copy. Further, facsimile transmission may result in a poor quality image, and small print in an advertisement may be illegible.

The media organizations also have the problem of assuring that they receive payment for the ads that are run. Finally, they must provide some type of proof, such as a tear sheet, to the customer, so that the customer is secure in the knowledge that the advertisement has in fact been published.

There have been companies or agencies that have, for a fee, taken over the task of placing advertisements for customers. While this approach is extremely helpful from the customer's point of view in that the burden of dealing with the numerous media organizations is lifted, much of the complexity of the process still exists and is just shifted from the customer to the company or agency handling the advertising placement. Thus from the media organization's point of view there exists a great need for a system and method for handling the placing of advertising copy that is convenient, automates the process, provides for payment to the media organization for an advertising campaign that is run, and finally provides proof to the customer that the appropriate advertisements have appeared.

### SUMMARY OF THE INVENTION

It is an object of the invention to provide a system and method that an advertiser can conveniently use to place an advertising campaign.

It is another object of the invention to provide a system and method that an advertiser can use to place bids on advertising space at discounted prices.

It is yet another object of the invention to provide a system and method that conveniently provides for payment for advertising space in a safe, secure and timely manner, thus enhancing cash flow for a media organization.

It is still another object of the invention to provide a system and method that provides electronic verification to an advertiser that an advertisement has been run.

It is still another object of the invention to provide a system and method that permits a media organization to make unused advertising space available to customers, possibly at discount, so that the space can be sold in a timely manner.

It is still another object of the invention to provide a system and method that permits very low, or n o cost electronic handling of advertising copy so that it can be easily transmitted, received, reviewed for content and processed.

It is a key object of the invention to provide a system and method for accomplishing the above and other objects of the invention by using standard internet access software.

In accordance with the invention, an apparatus and method are provided for advertisers to place advertisements with media organizations through a management system having a database. The invention comprises advertisers accessing the database so as to place offers representative of an advertising campaign in the database. Users at a media organization access the database so as to review the offers, and to accept or decline the offers, or postpone making a decision until a later time. If an offer is accepted, an insertion order is generated to insert the advertisement in accordance with the offer. An electronic message may be generated which provides proof that the advertisements in accordance with the insertion orders have been run. The electronic message is sent to the advertiser, preferably in the form of an electronic affidavit. Payment may be provided to the media organization after the electronic message has been sent. Preferably, the advertiser has a period of time in which to contest the electronic affidavit before the payment is released to the media organization.

If an offer is declined by a media organization, a reason must be provided. This information may be provided by the system manager to the advertiser, so that the advertiser may make a revised offer which may be acceptable to the media organization.

Funds are transferred using a secure network. Credit card information may be sent and validated using the secure network. Alternatively, an electronic check or an electronic wallet account may be used.

The system and method may be operated so that providing payment includes determining when a period of time has elapsed after the advertisements are run, and transferring funds after the period has passed. The period of time starts after the media organization provides a message to the advertiser that an advertisement has been run.

The database is included in a system manager comprising a transaction server, a web browser, and a series of program objects programmed to run on the transaction server.

The advertisers, the media organizations and the database are connected with a network, which may be a private network or in accordance with the preferred embodiment, the Internet.

### BRIEF DESCRIPTION OF THE DRAWINGS

The above set forth and other features of the invention are made more apparent in the ensuing detailed description of the invention when read in conjunction with the attached drawings, wherein:

FIG. 1 is a very high level system diagram of a system in accordance with the invention.

FIG. 2 is a flow chart of the manner in which an advertiser interacts within the system of FIG. 1.

FIG. 3 is an advertiser logon screen used in the system of FIG. 1.

FIG. 4 is an advertiser welcome screen used in the system of FIG. 1.

FIG. 5 is an advertiser campaign detail screen used in the system of FIG. 1.

FIG. 6 is an advertiser campaign editing screen used in the system of FIG. 1.

FIG. 7 is an offer generation screen presented to the user of the system of FIG. 1.

FIG. 8 is a newspaper selection screen presented to the user of the system of FIG. 1.

FIG. 9 is a billing information screen presented to the user of the system of FIG. 1.

FIG. 10 is a schematic representation of the network interconnections used to effect secure payment by means of a credit card.

FIG. 11 is a flow chart of the manner in which a newspaper interacts within the system of FIG. 1.

FIG. 12 is a newspaper logon screen used in the system of FIG. 1.

FIG. 13 is a media organization user welcome screen.

FIG. 14 is an offer details screen provided for the media organization user.

FIG. 15 is an insertion order confirmation screen provided for the media organization user.

FIG. 16 is system manager interface screen used by a person managing the system of FIG. 1.

FIG. 17 is a master campaign list, which may be accessed via the screen of FIG. 16.

FIG. 18 is a diagram representing the relational data-base stored on the database server of FIG. 1.

### DETAILED DESCRIPTION OF THE INVENTION

In the following discussion, the term advertiser and customer are used to refer to a business or individual that wishes to place advertisements to sell a product or service or to promote a particular agenda. While the advertisements may be placed with any media organization such as a newspaper, magazine, radio station, television station, etc. to simplify the discussion, reference is generally made herein to placing advertisements in newspapers. Thus, in the discussion below, it is print advertising copy that is being processed. However, as bandwidths of networks increase, the principles of the invention may be applied to the processing of high quality files representing radio or television advertisement to be broadcast by selected radio and television stations.

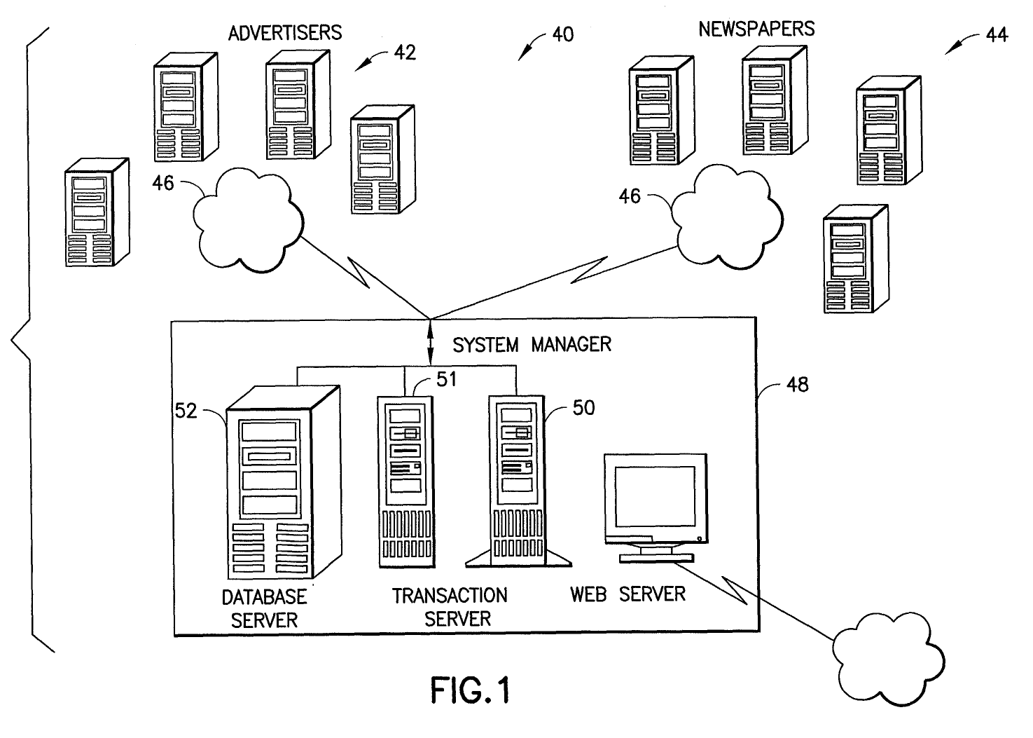

Referring to FIG. 1, a system 40 in accordance with the invention may include, in broad terms, a group of customers or advertisers having computers 42, including, for example businesses which wish to run advertising campaigns using various ones of a large group of media organizations, such as, for example, newspapers also having computers 44. The computers 42 and 44, of the advertisers and the newspapers respectively, are connected by a large network, such as the internet, shown generally at 46, to a management system 48 which controls the exchange of information between the advertisers' computers 42 and the newspapers' computers 44.

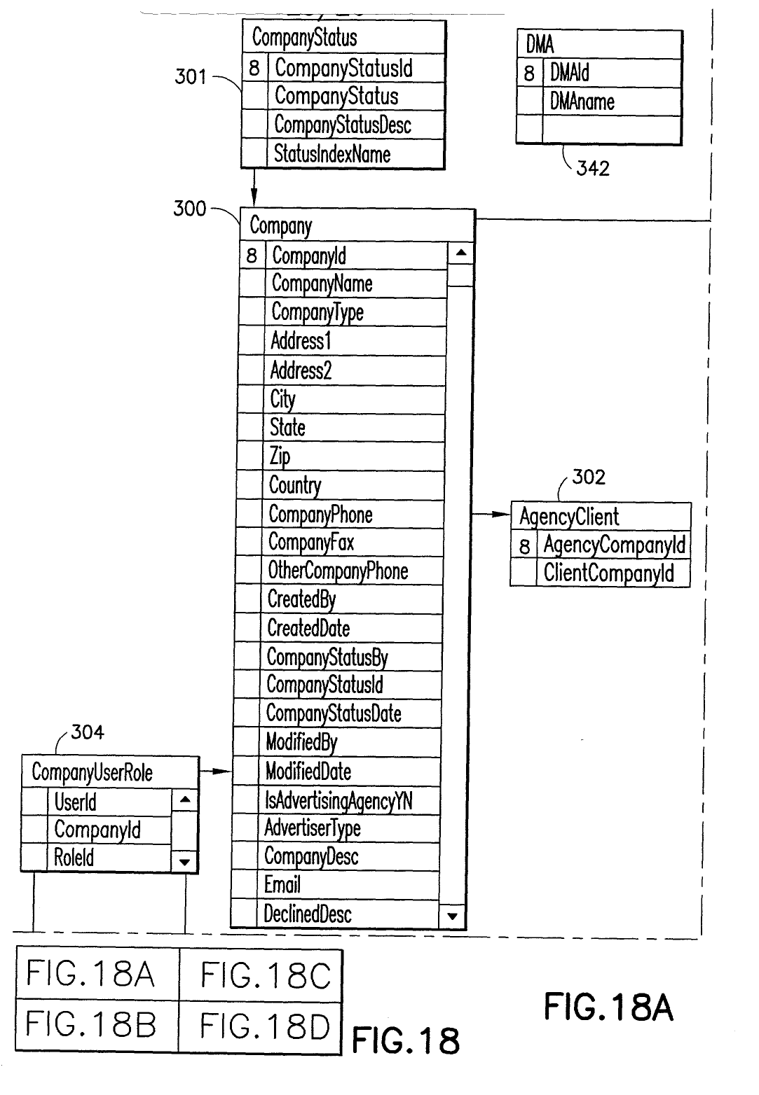

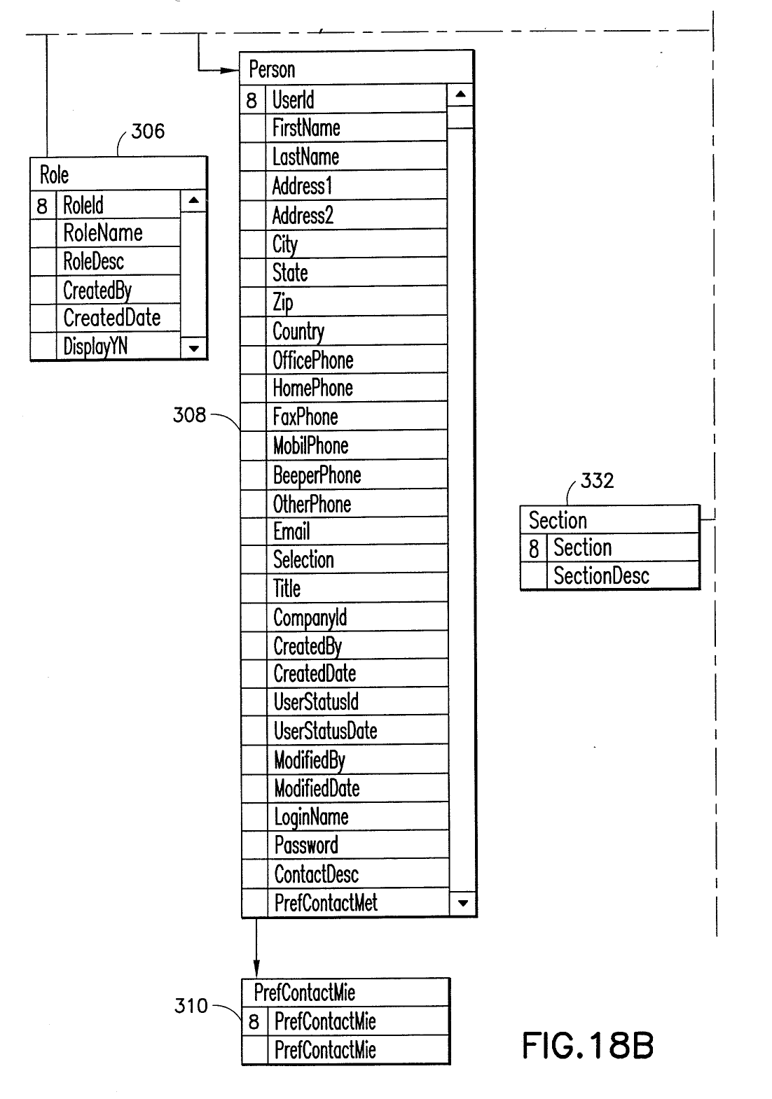

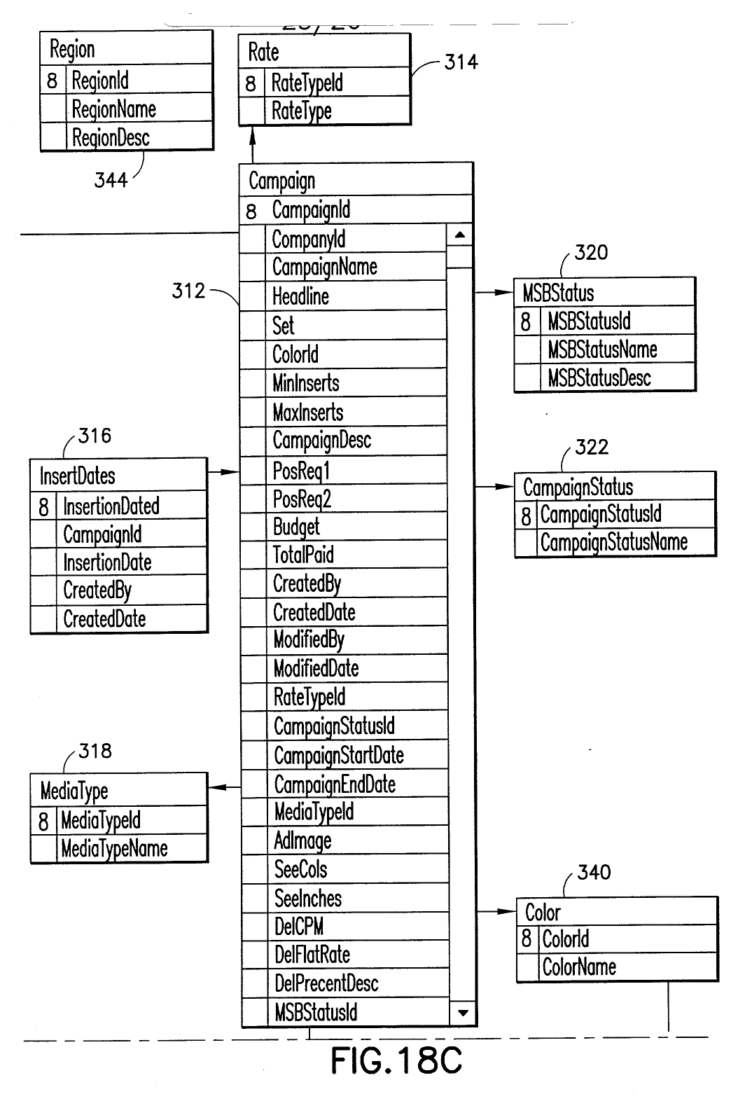

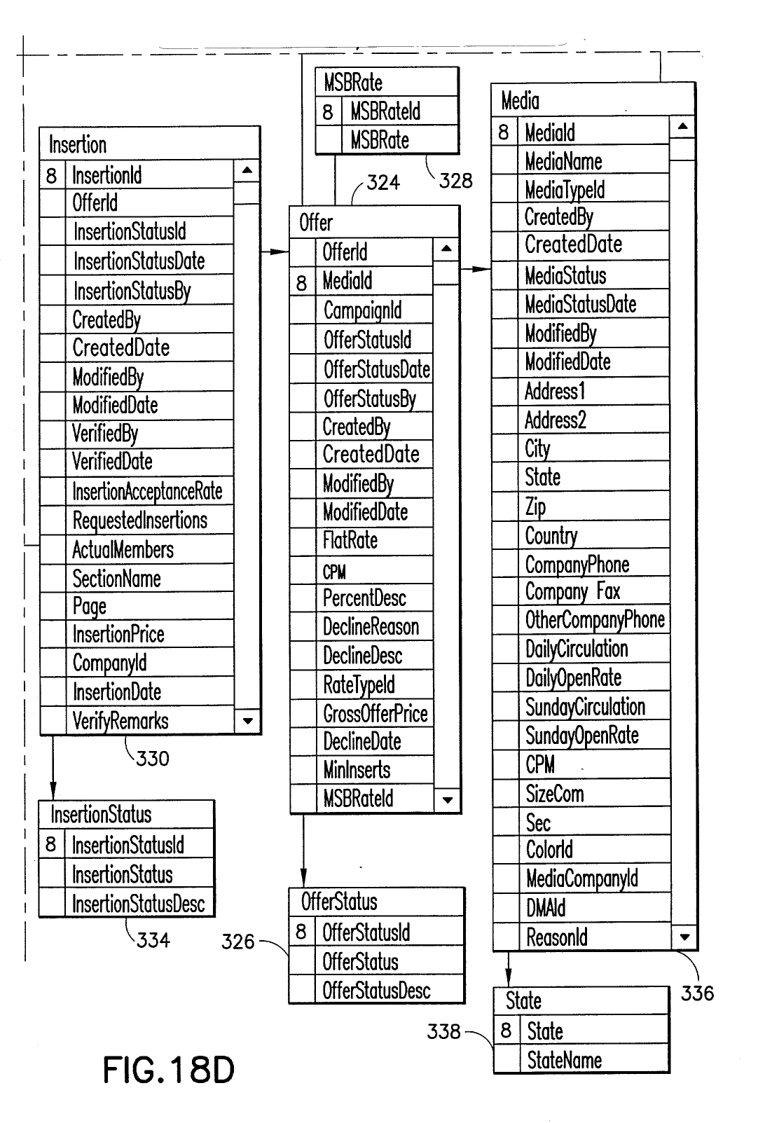

Management system 48 generally includes a web server 50, a transaction server 51 and a database server 52. Web server 50 permits advertisers 42 and newspapers 44 to interact with management system 48. Web server 50 can access the information on database server 52, by means of transaction processor 51 so as to run queries and perform various analyses on the acquired data and to bring data to the web-based platform. Database server 52 includes a complex database structure, implemented in Microsoft SQL as more fully describe below with respect to FIG. 18 including among other things, files having data concerning the advertisers, newspapers, advertising campaigns placed and completed, pricing information, and data concerning DMA's (distinct market areas) useful to advertisers to assist them in planning their advertising campaigns. A web application program, such as Microsoft ASP (Active Server Pages) resides on transaction server 51. The program responds to appropriate program components (or objects stored as DLL files), written in visual basic code, acting as an intermediary between the browser of web server 50 (which operates using HTML) and the visual basic of the objects residing on transaction server 51. In other words, database server 52 stores the required information, transaction server 51 processes the information, and web server 50 includes a web browser that receives and displays the information. The system manager, which may be implemented using hardware including, for example, an AS-400 computer manufactured by International Business Machines Corporation, is advantageously configured to perform all required functions for the system and method according to the invention to operate. Thus, the users of the system, whether advertisers or media organizations, need only have a standard web browser and a viewer for viewing of the files created for the advertisements that are to be run. Generally the files will be in PDF format, but it will be understood that other file formats can be used.

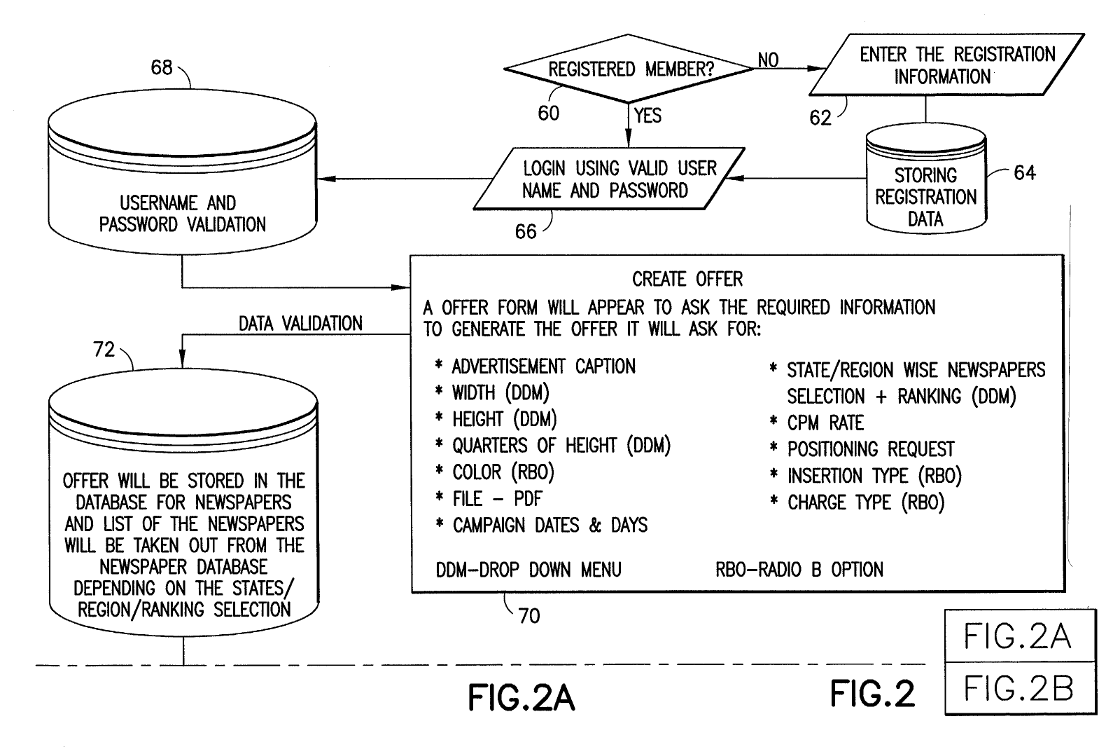

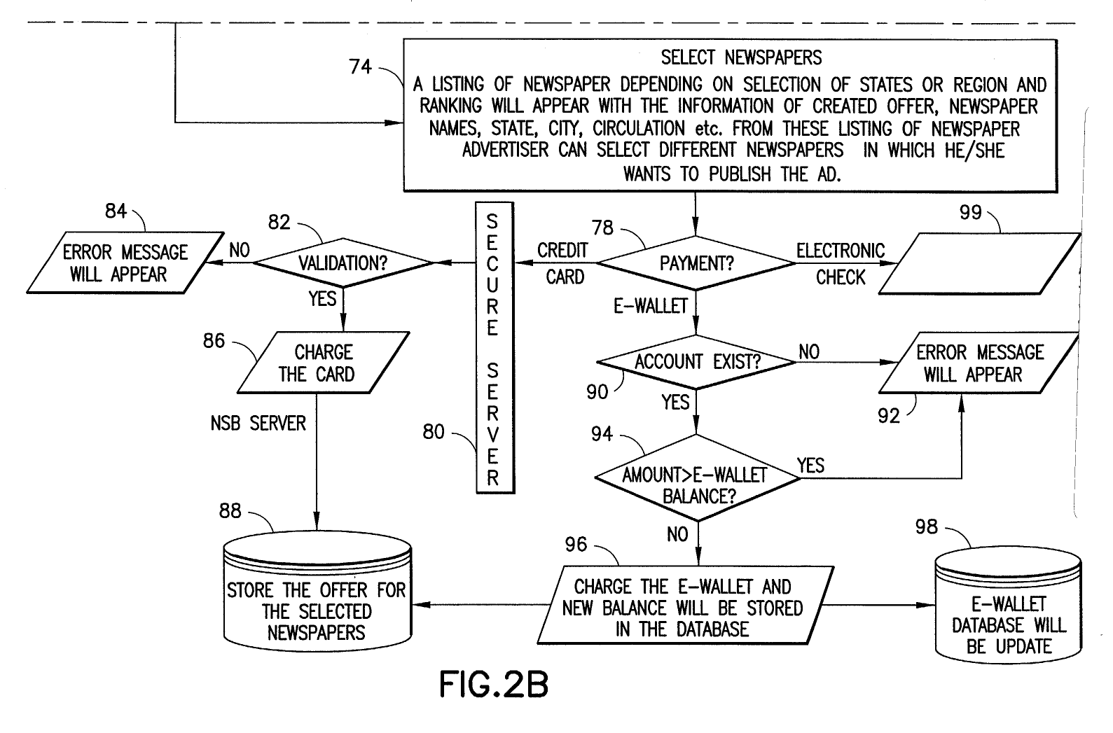

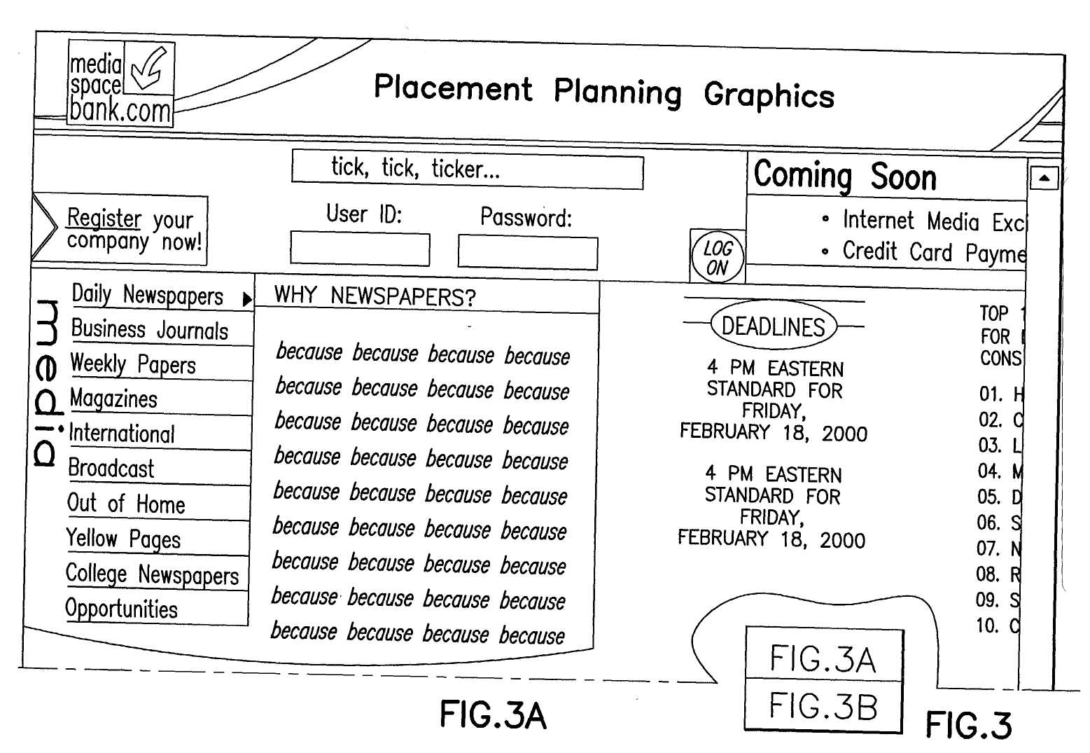

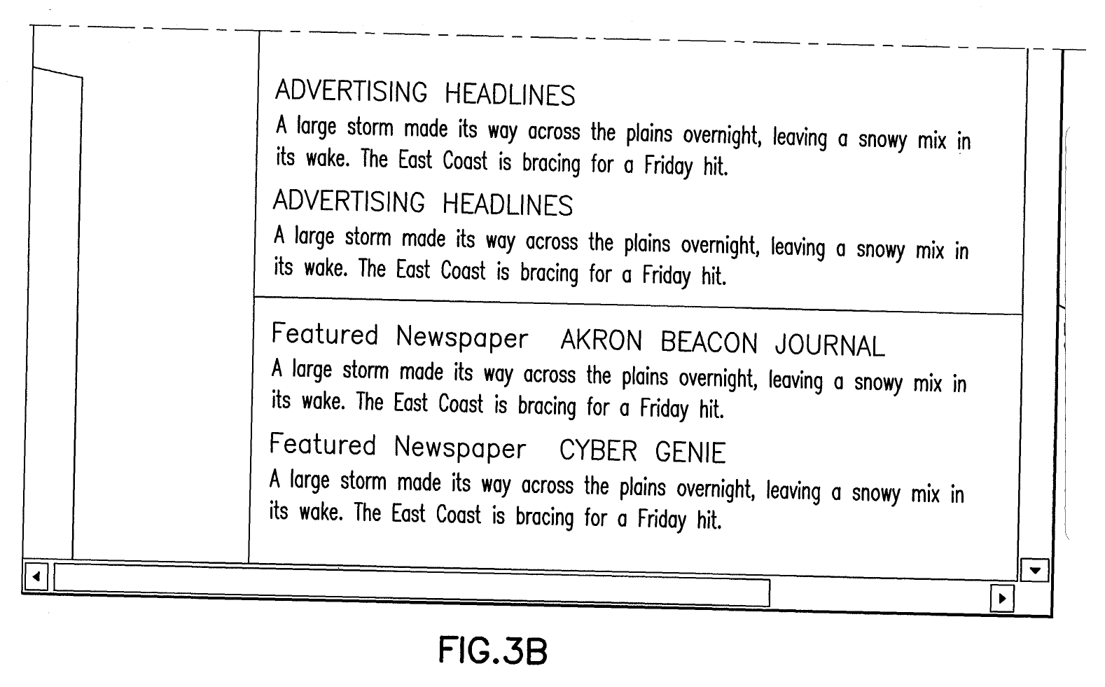

Referring to FIG. 2, when a user or advertiser logs on to the system at 60, a determination is made as to whether that individual or business entity is already registered by the use of, for example, a logon screen, of the type illustrated in FIG. 3. FIG. 3 provides for a new member to register, or for a registered user to enter a name and password by using a keyboard and a mouse and clicking at the appropriate place. If the user is not already registered, then appropriate screens are provided at step 62 so that the user can enter registration data. At step 64, the registration data is stored in the appropriate portion of the database discussed below with respect to FIG. 18.

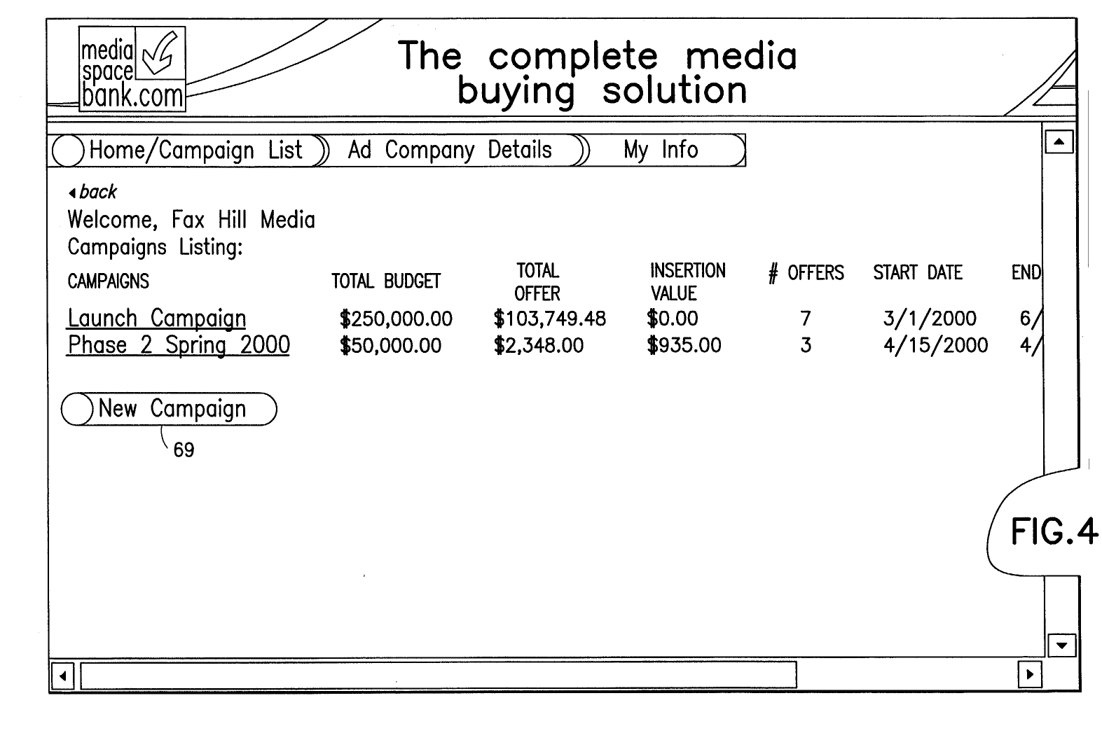

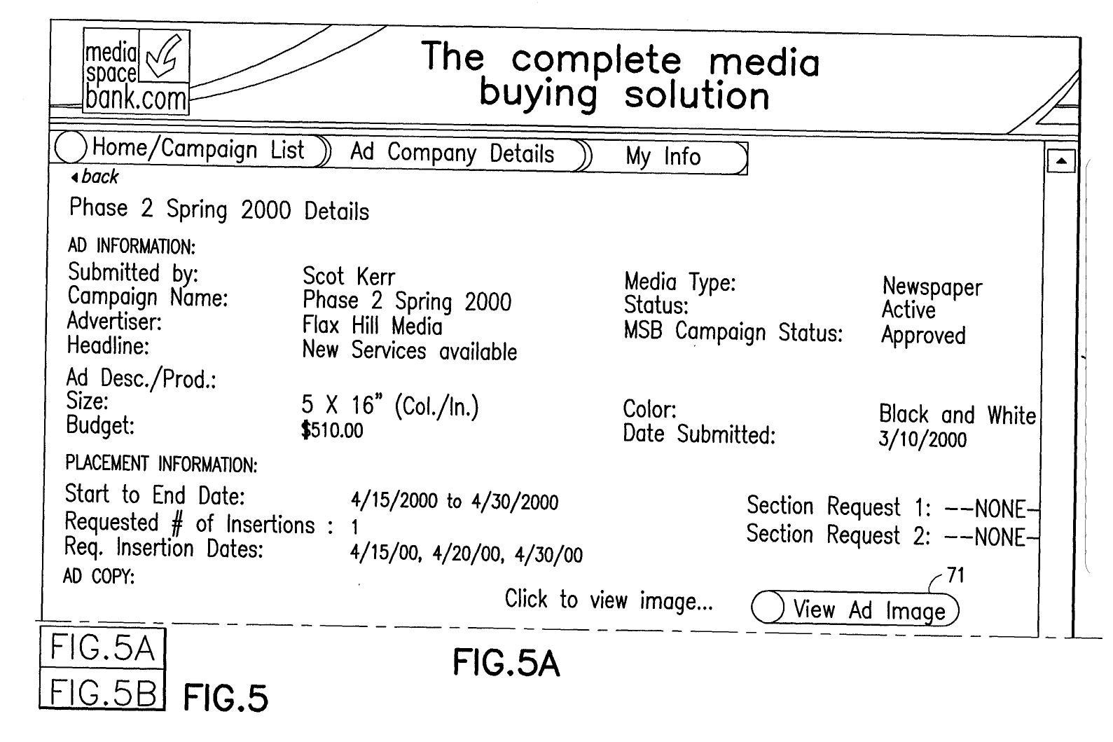

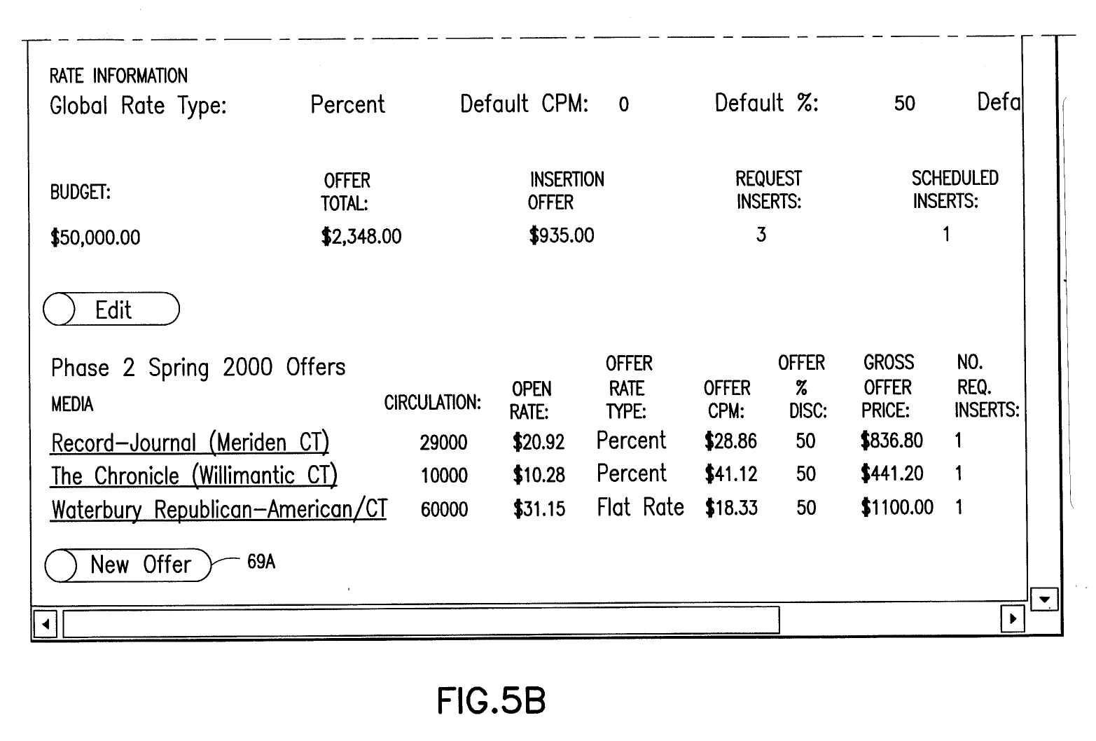

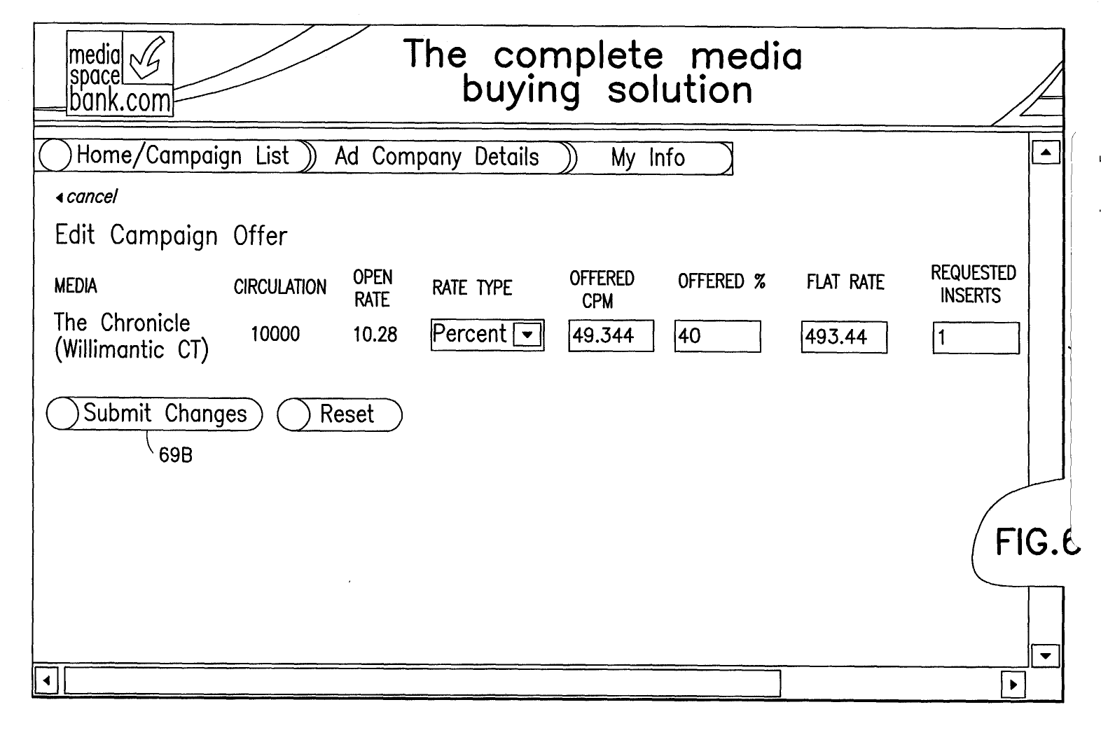

At step 66 the user has logged into the system by entering a valid user name and password at the screen of FIG. 3. The user name and password are validated at step 68. If the entered information is valid the user is eventually permitted to create an offer at step 70. However, first a welcome screen, as illustrated in FIG. 4, is provided. This screen provides a summary of all active campaigns for that particular advertiser. The user has the option of clicking on a new campaign button 69, or clicking on the individual previously entered existing campaigns, which are listed. If the user clicks on one of the existing campaigns, then a screen of the type of illustrated in FIG. 5 is displayed. This screen provides the details of the selected campaign, including the ability to view the image of the advertisement by clicking on a button 71. If an offer has not been accepted, the user can click on a new offer button 69A to bring up a screen of the type illustrated in FIG. 6.

FIG. 6 illustrates an important aspect of the present invention. When an advertiser presents a series of offers, each media organization presented with an offer has the opportunity to accept the offer, decline the offer or wait. To the extent that the offer is clearly acceptable, the media organization has an incentive to accept it upon first viewing. On the other hand, if the offer is not within acceptable parameters for that media organization, in that, for example, the price is much too low and would never be acceptable, then the offer can be declined. Alternatively, the offer can be decline for any one of several reasons as more fully discussed below. However, there are situations where the media organization may simply choose to wait to see whether more attractive offers become available. In this case, the advertiser would see the offer as remaining open; that is not accepted or declined. The advertiser then has the option of using the screen of FIG. 6 to revise the offer, by using a button 69B, in the hopes of making it more palatable to the media organizations and having it accepted. Alternatively, if sufficient other offers in the area have been accepted, the advertiser has the option of withdrawing the offer before it is accepted. Thus, the present invention provides both advertisers and media organizations with maximum flexibility in that the advertisers can attempt to obtain advertising space at a discount, while the media organizations can see whether better offers for particular issues of the newspaper become available, or whether there are none. In the latter case it may be in the best business interests of the media organization to accept the offer from the advertiser, so that the available space can be sold.

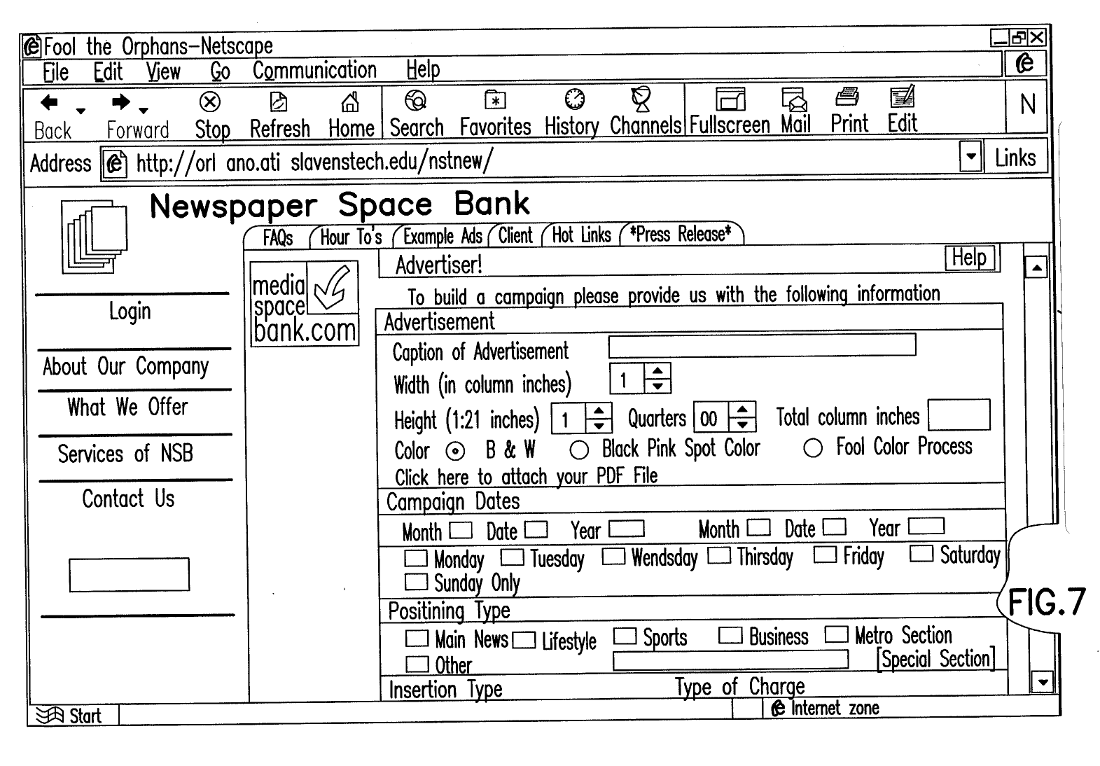

Referring again to FIG. 4, if a new campaign is to be generated by clicking on button 69, a screen of the type illustrated in FIG. 7 is presented. This screen is provided so that the user can enter information such as the advertisement caption, dimensions of the advertisement, color information, campaign dates and days, state and/or region newspaper selection and rankings, positioning requests, insertion type, number of insertions, charge type and the so-called CPM rate (the cost per thousand circulation of the newspaper).

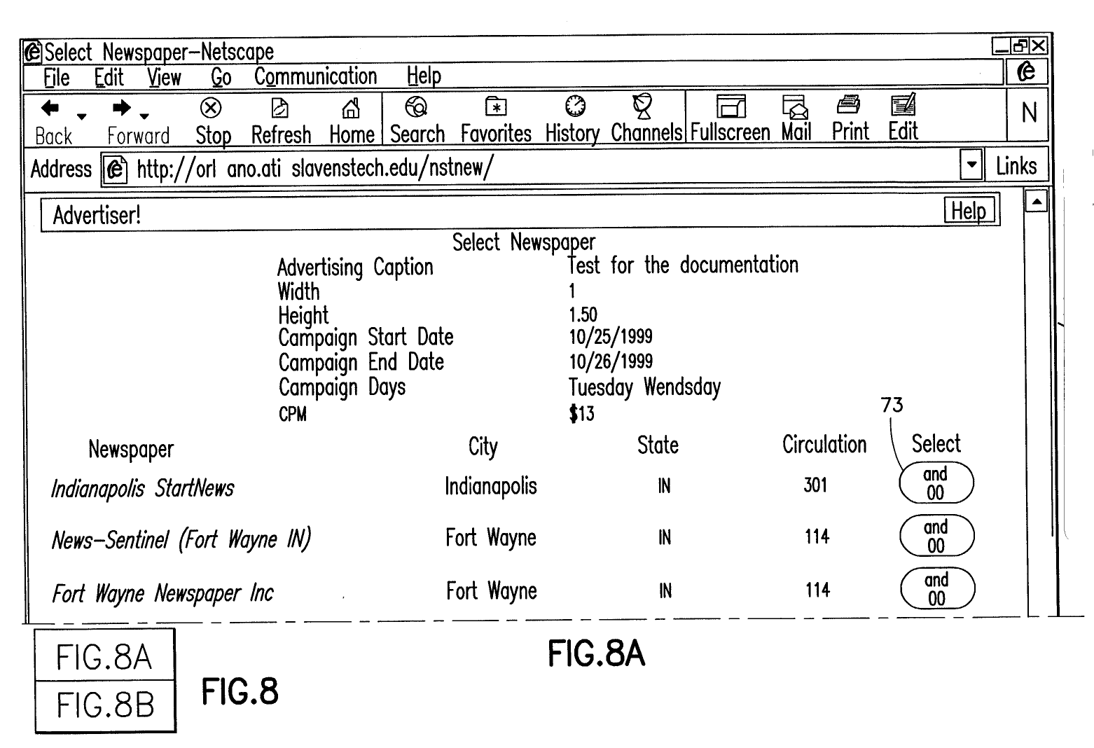

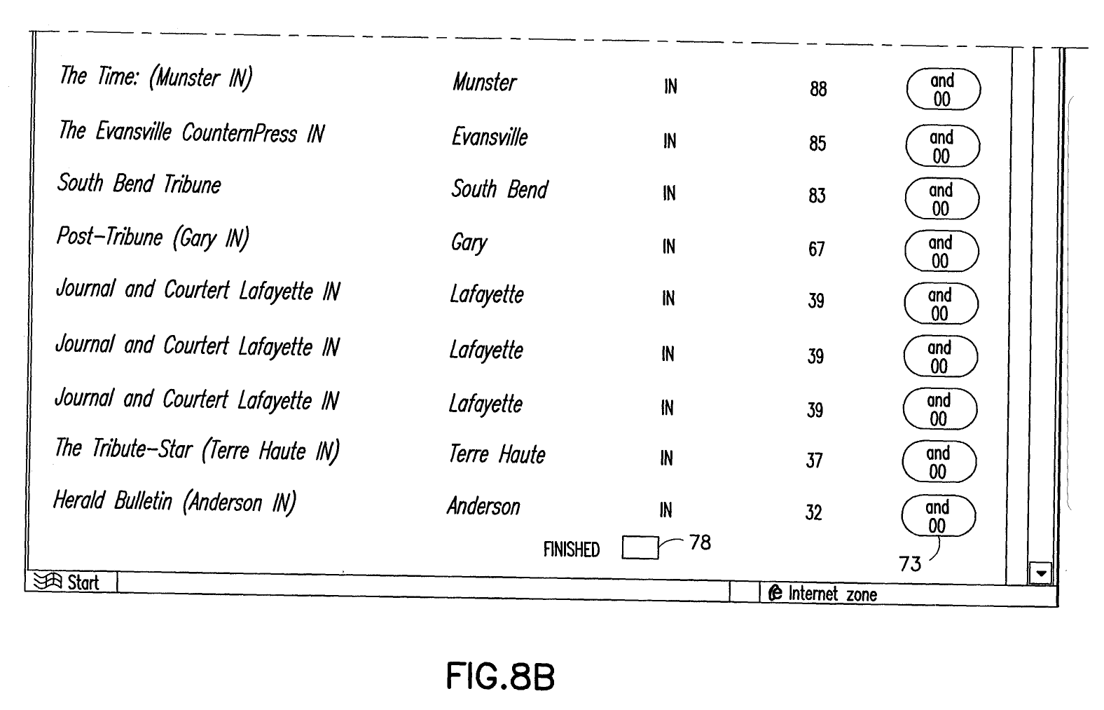

Referring again to FIG. 2, at step 72 the offer is stored in the database. Newspapers and lists of newspapers are compiled from those stored in the newspaper database, depending on selections made in generating the offer. Once the offer has been generated and submitted by the user, at step 74 the lists of newspapers are presented to the user in a screen having a form such as that of FIG. 8. This screen provides the details of the advertisement entered at the screen of FIG. 7, as well as a listing of newspapers including newspaper name, city, state, circulation and various pricing parameters. The user is given the opportunity to select the newspaper where the campaign is to be inserted by clicking on a respective check box 73.

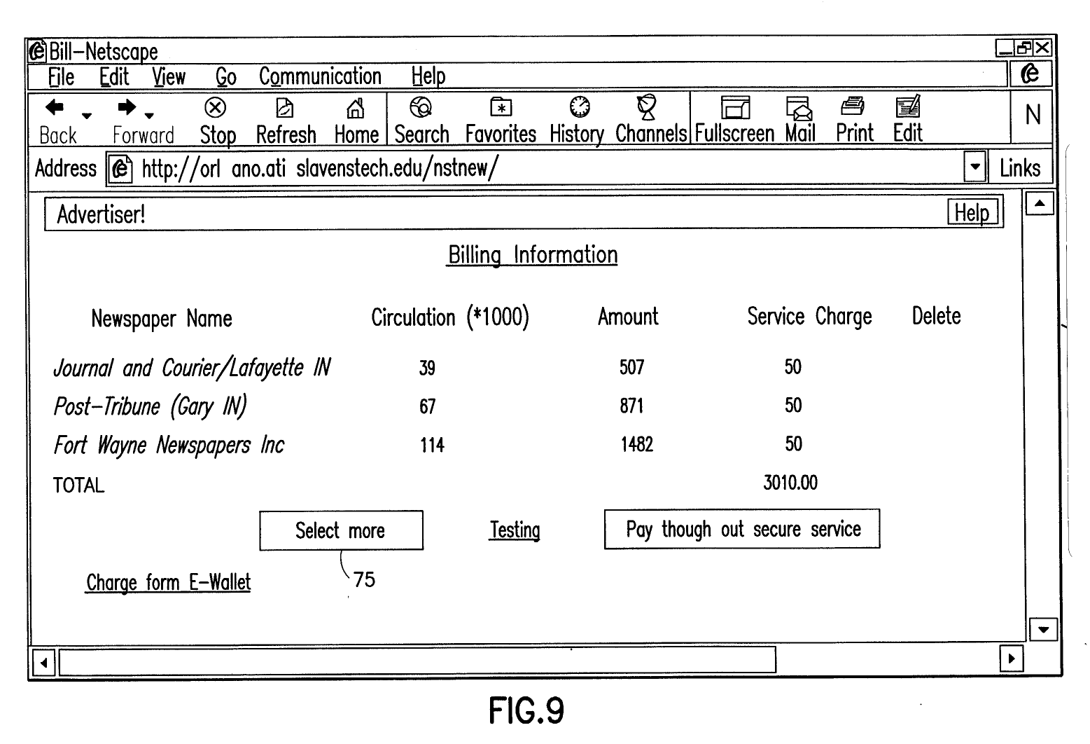

When the user clicks on the name of a particular newspaper, the screen of FIG. 9 appears. The user is provided with billing information for the newspaper that has been selected. After reviewing this information, the advertiser may select more newspapers by clicking on the “select more” button 75 of FIG. 9. In that case, the screen of FIG. 8 reappears, and the user can select additional newspapers. When the user has made all the selections desired, button 77 of the screen of FIG. 8 is activated, and returning to FIG. 2, a mode of payment is selected at step 78.

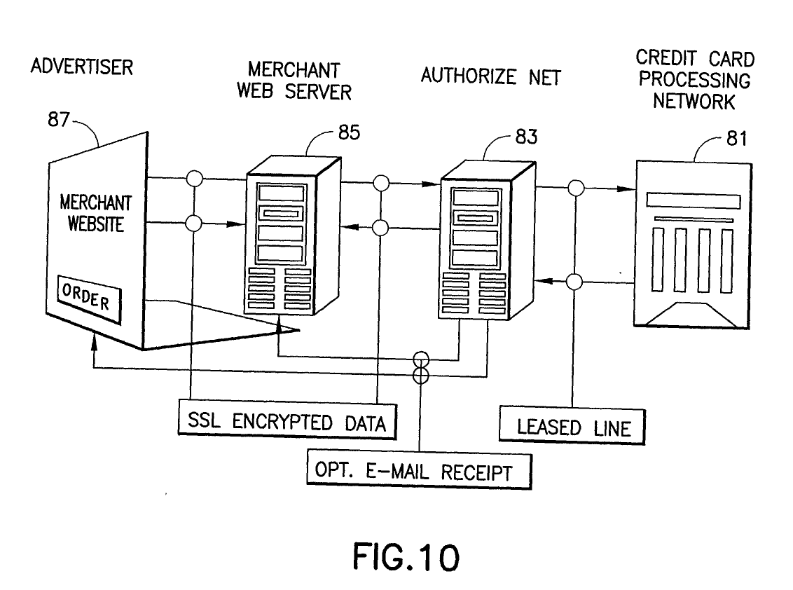

One mode of payment that can be selected is the use of a credit card by means of accessing a secure server at step 80, in accordance with the set of network interconnections illustrated in FIG. 10.

FIG. 10 provides an example where a credit card processing network 81 associated with for example, a financial institution such as a bank, communicates with an authorized network server 83 over secure leased network lines. Authorized network server 83 in turn communicates with a merchant web server 85 using, for example, SSL encrypted data. The advertiser uses the screens 87 provided by the merchant web server 85 to enter appropriate credit card data. It is preferable that the system manager does not assume responsibility for credit card data. When information is provided by the advertiser, it is transferred to the authorized network server 83, which performs the necessary transaction for a validation of the credit card information. When the validation is complete, a subroutine on the system manager 48 runs to acquire the confirmation code from the authorized network 83. The campaign, consisting of the various offers, is provided to the media organizations only if the credit card data has been properly validated. Validation may include checking items such as ownership of the account, the date of expiration of the credit card and whether the total amount authorized for the campaign is within the credit limits for the particular account being used. If desired, the system may be configured to provide an e-mail receipt to the advertiser when validation has been completed, and/or when the credit card account has actually been charged.

Returning to FIG. 2, at step 82 validation of the credit card information is conducted. If the credit card information is not valid in that the account has been closed or is overdrawn, an error message is presented at step 84. However, if validation is successful, a hold is placed on the credit-card account for the required payment at step 86, and the offers for the selected newspapers is stored in the campaign database file (FIG. 18, item 312) at step 88.

An advertiser may also maintain a so-called E-wallet account and may select that mode of payment. If this mode is selected, at step 90 a determination is made as to whether or not an account exists. If no account exists, an error message appears at step 92. If an account exists, at step 94, a determination is made as to whether the amount to be charged to the account is larger than the balance in the account. If the amount is larger, then an error message appears at step 92. If not, a hold is placed on the account for the appropriate amount at step 96. The E-wallet database is updated at step 98 and the offers are stored for the selected newspapers in the campaign database at step 88.

Another possible payment method is the use of an electronic check at step 99.

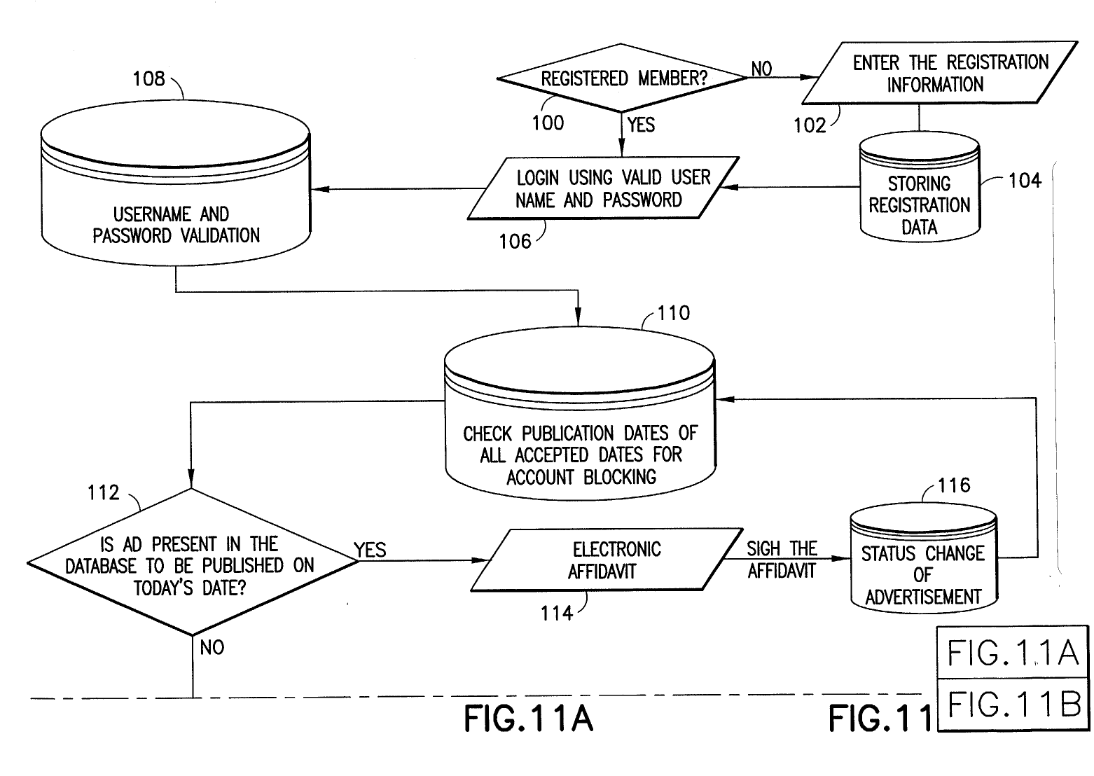

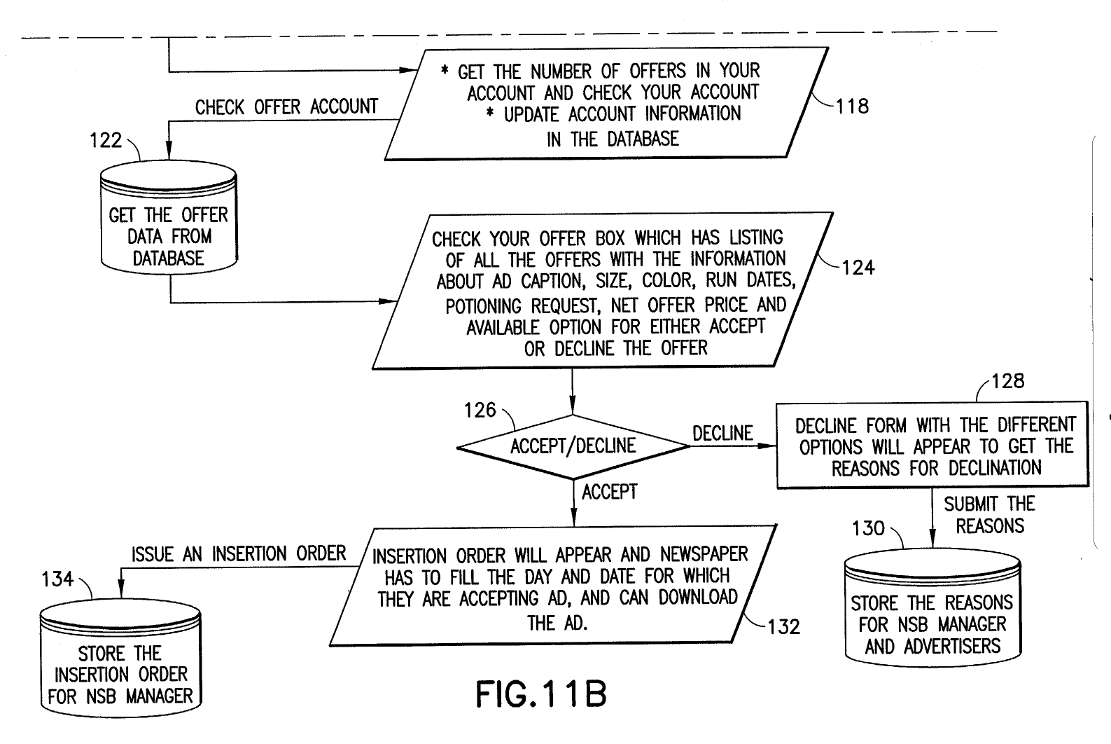

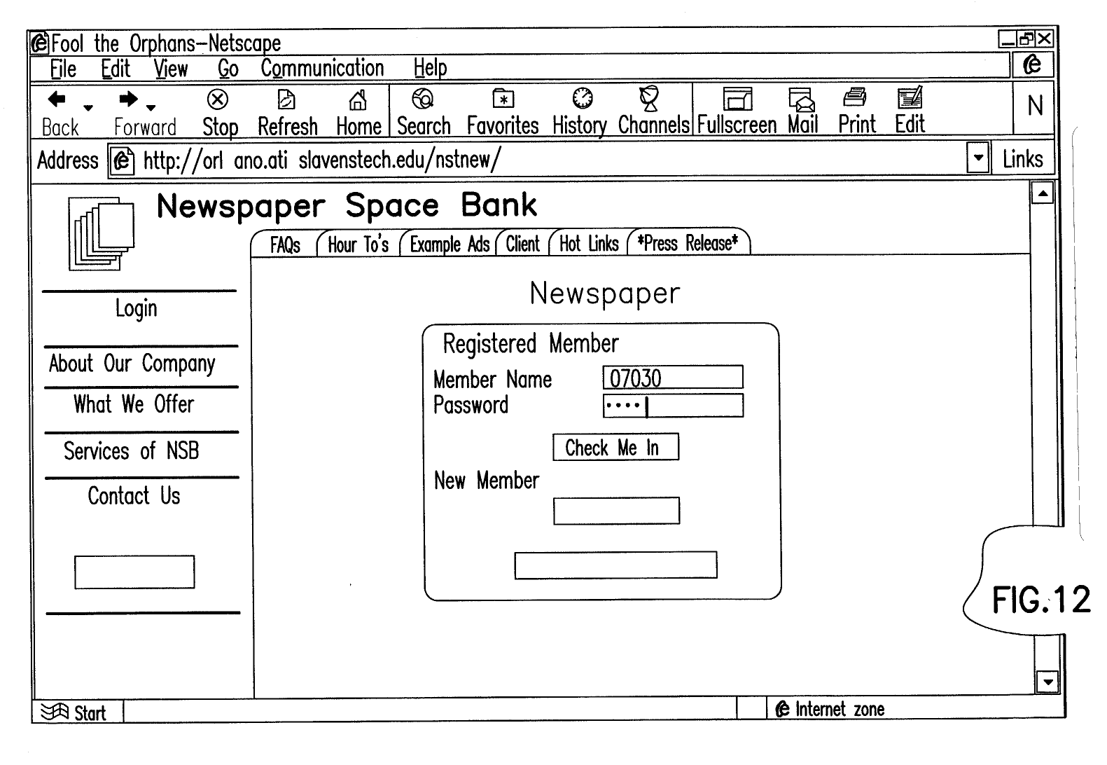

FIG. 11 illustrates the manner in which a newspaper interacts with the system of FIG. 1. A logon screen of the type shown in FIG. 12, or one similar to that illustrated and FIG. 3 is presented to the user at the newspaper. Steps 100 to 108 of FIG. 11 are essentially identical in operation to steps 60 to 68 of FIG. 2. At step 102, the registration data is stored in the appropriate portion of the database discussed below with respect to FIG. 18.

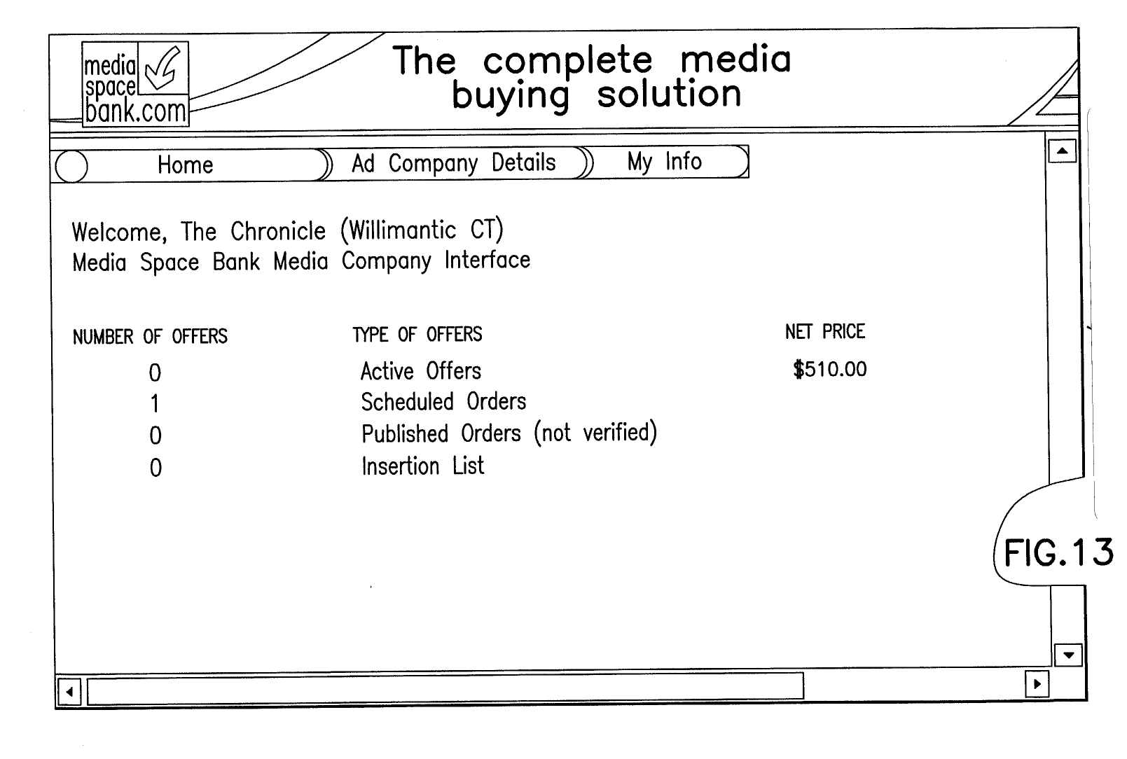

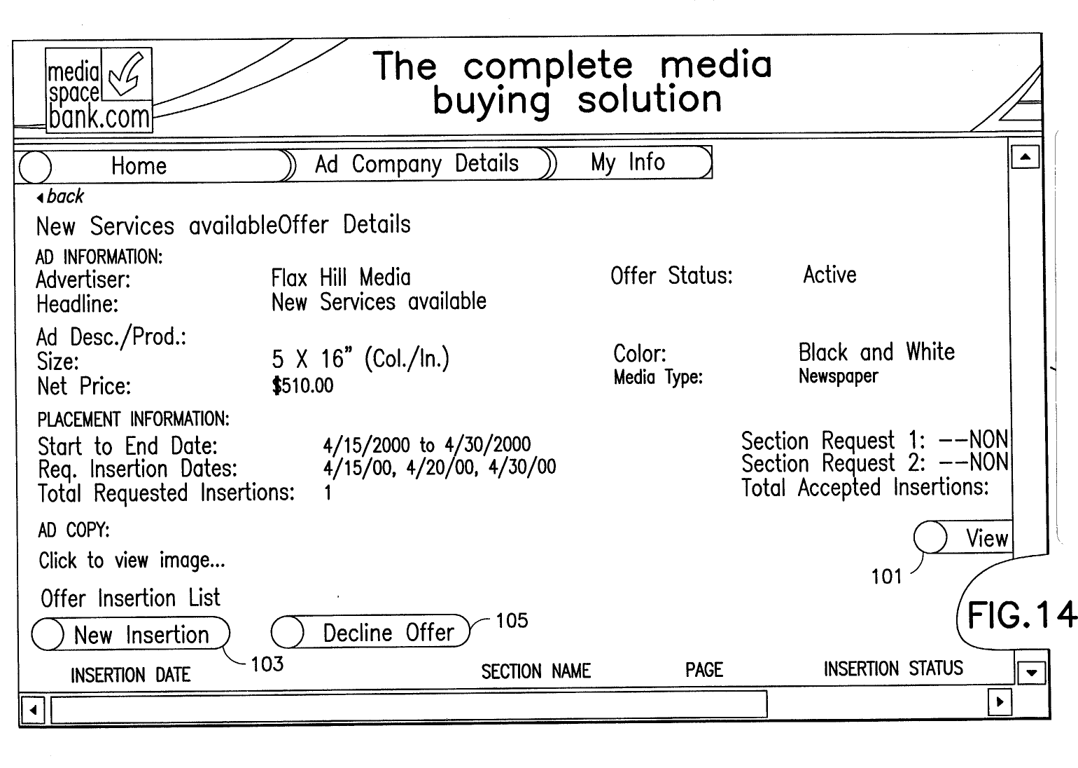

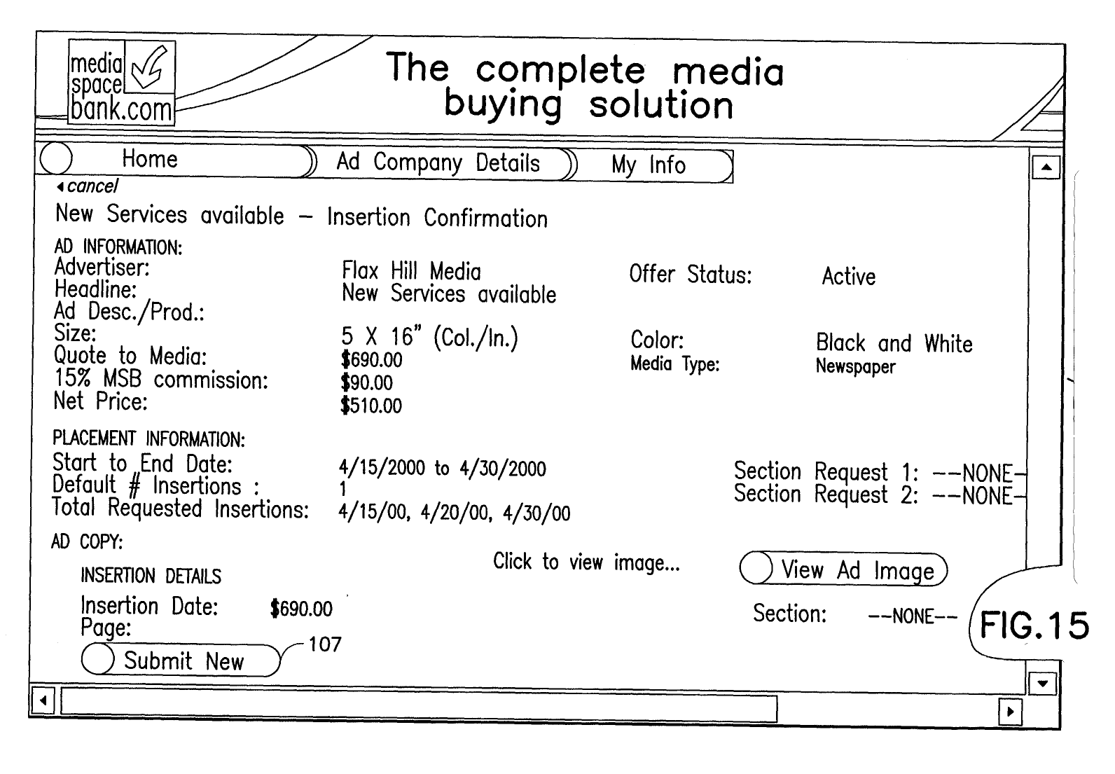

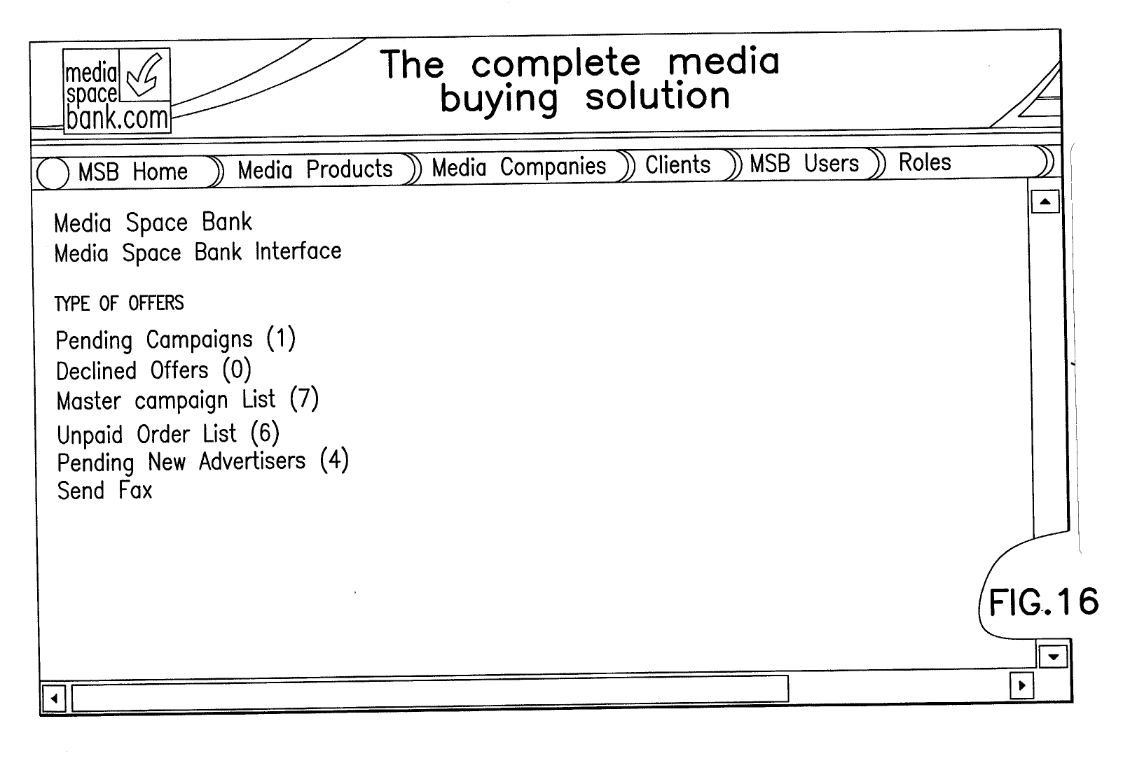

Once logon has occurred, a welcome screen of the type illustrated in FIG. 13 is displayed to the user at the media organization. By clicking at the appropriate place the user can get the details of active offers, scheduled orders, published orders and insertion lists. If the user clicks on active orders, a screen of the type illustrated in FIG. 14 is displayed. The user may view the advertisement by clicking on button 101, accept the offer by creating a new insertion by clicking on button 103, or declined the offer by clicking on button 105. If an insertion order is created by clicking on button 103, a screen of the type illustrated in FIG. 15 is generated. Clicking on a button 107 on this screen permits the user to generate additional insertion orders.

Referring again to FIG. 11, at step 110 a check is made by the user at the media organization of all accepted publication dates so that the appropriate advertiser accounts can be charged. At step 112 a determination is made as to whether the advertisement is present in the database so as to be published on the present date. If the answer is yes, an electronic affidavit is generated at step 114. If the affidavit is signed by the user at the media organization, then at step 116 a change in the status of the advertisement occurs. The appropriate database file is updated by returning to step 110. Further, as soon as the affidavit is signed, it is sent by e-mail to the system manager 48 so that it can be forwarded to the advertiser. Thus, the advertiser has proof that the advertisement has run in the appropriate newspaper.

At step 118, the user at the media organization can check on the number of active offers by clicking on the Active Offers line of the screen of FIG. 13. As discussed above, offers may have been withdrawn or a better offering price may be available for insertions of advertisements for a particular campaign. At step 122, the active offers are retrieved from the database and listed to a screen. At step 124, the details of a particular offer can be viewed in a screen of the type illustrated in FIG. 14. At step 126 a decision can be made as to whether or not to accept or decline the offer. If the offer is declined, at step 128 the media organization user must provide a reason for why the offer has been declined. These reasons may include inappropriate content of the advertisement, an insufficient financial offer, size of the advertisement, or any other reason. For the latter two reasons, the user is provided with a text block to elaborate on the reason and to automatically send an e-mail message to the system manager detailing the reasons for the declination. At step 130, the reasons for the declination are stored in the database of FIG. 18.

If, at step 126, the advertisement is accepted, an insertion order will be generated at step 132. At this point the media organization has committed to run the advertisement on the particular day and date and can download the PDF file for the advertisement from the database. At step 134 the insertion order is stored in the appropriate portion of the database of FIG. 18.

As noted above with respect to FIG. 2, it is also possible for the user at the media organization to postpone accepting or declining the offer. The list of pending offers can be reviewed at a later time and the offers then accepted or declined based on the current business situation.

FIG. 16 is a screen which illustrates how a person at the system manager interacts with the system of FIG. 1. After logging on using an appropriate user ID and password at a screen (not shown) provided for this purpose, the management user can review pending campaigns, declined offers, a master campaign list, an unpaid order list, and pending new advertisers. The management user also has the capability of sending facsimiles, as more fully described below.

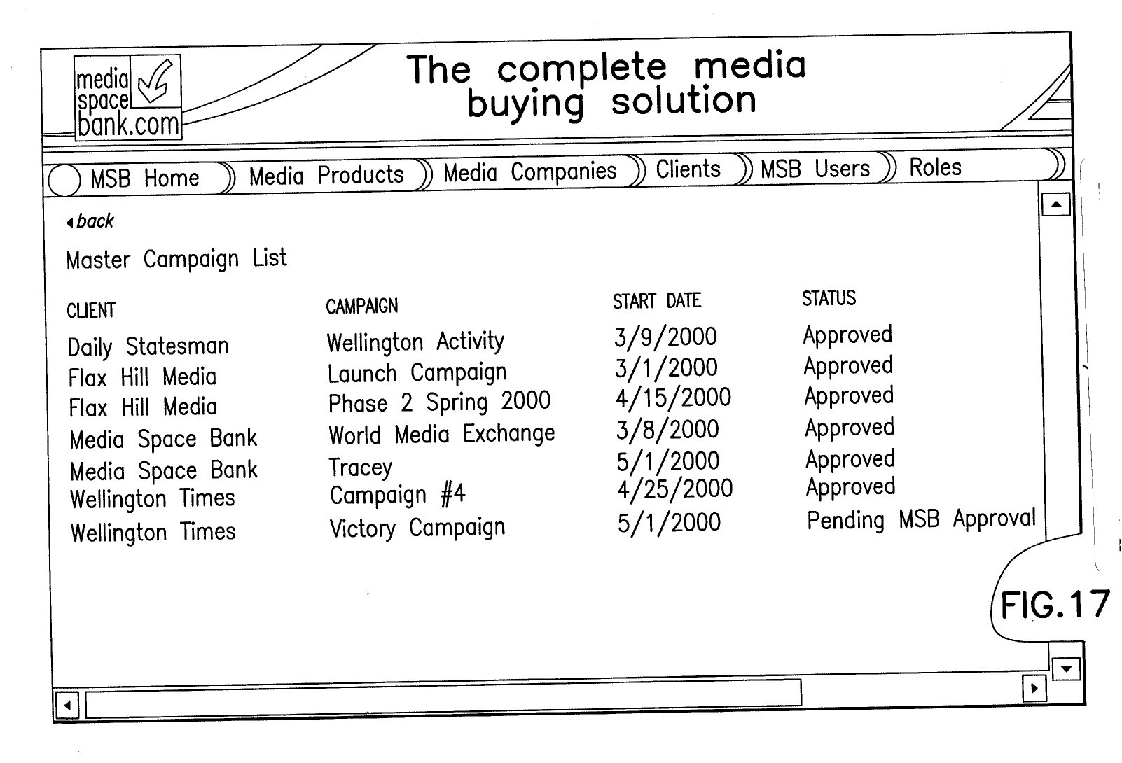

FIG. 17 is accessed by clicking on the master campaign list portion of FIG. 16. All of the campaigns in the system are summarized by client, campaign name, start date and campaign status.

The system manager user has the ability to change user profiles, maintain accounts, and check and track insertion orders. An important function of this user is to review the flow of electronic affidavits so that appropriate payments are received from the advertisers and appropriate funds are dispersed to the advertisers, with the difference between the two being held as profit for the organization which owns the system manager.

When an electronic affidavit is provided to the advertiser as evidence that an advertisement has been run, the advertiser has a period of five days within which to challenge the accuracy of the affidavit. The advertiser may object to payment for one of several reasons. For example, the advertiser may independently verify that for some reason the advertisement was not run, although this is very unlikely. Another possibility is that the printing process made some portion of the advertisement illegible. Still another possibility is that a portion of the advertisement was not printed. However, since the system allows a system manager user to carefully review electronic files submitted by an advertiser, which is done for content and technical suitability, this is not likely if the processing of the files by the newspaper is also done electronically. However, in some cases there may be newspapers which do not regularly use the system. In these cases it is necessary to include a fax facility in the system to fax offers and advertising copy to the newspaper. In such cases, there exists a much greater margin for error due to transmission and typesetting problems.

In any event, if within five days the advertiser does not objected to the affidavit, the system manager charges the advertiser's account for the gross cost of that insertion. As soon as the funds are received, the net proceeds are forwarded to the newspaper that ran the advertisement. Thus, to the extent that the user at the newspaper is diligent in providing the necessary affidavits as proof of publication, the cash flow to the newspaper is greatly enhanced, because it is possible to receive payment within five days. This is in sharp contrast to the usual wait of months, especially if a monthly billing cycle is used, which may result in a bill not being sent out, much less collected, for nearly two months.

It is also possible for the management system user to track insertion orders through an insertion order number which is generated with an insertion order.

FIG. 18 illustrates the structure of the SQL database used in the system according to the invention. File 300 includes data on all advertisers using the system. The information includes company identifier, company name, company type, address data, company telephone number, a company facsimile number, person creating the record, date the record was created, identity of person providing company status data, user ID data for that person, date company status data was created, person who modified a record, date the record was modified, whether the company is an advertising agency or not, the advertiser type, a description of the company, an e-mail address for the company, and if for some reason the company is not acceptable to the system manager as a company with which to do business, a description of why the decision was made.

File 300 is linked to a company status file 301 which contains a company status identifier, company status, a status description, and a status fixed name.

A file 302, associated with file 300 is used for the situations where it is an advertising agency which interfaces with the system as the advertiser. In this case, identifiers for the agency and the company being represented by the agency are stored in file 302. This permits independent processing for each of the agency's clients.

A file 304 stores information concerning the role of different individuals at each company who use the system. The information includes a user identifier, the company identifier and a role identifier. File 304 is linked to a file 306 which includes the role identifier, the role name, the role description, who created the record, the date the record was created, and a flag for indicating whether the information contained in a record should be displayed when that person has logged on to the system.

For each person who uses the system a record is created in file 308. The information includes userid, first name, last name, address information, home telephone number, office telephone number, fax telephone number, mobile telephone number, beeper telephone number, other telephone number, e-mail address, salutation, title, company identifier, identity of the person creating the record, date on which the record was created, user status identifier, user status date, person who last modified the record, the date the record was last modified, the login name for that person, the person's password, a contact description, and a preferred method of contact. A file 310 maybe be used to store records listing more than one preferred method of contact.

A file 312 contains a record for each campaign. This data includes the campaign name or identifier, the company identifier, the company name, the headline, the size of the advertisement, color identification data, the minimum number of inserts requested, the maximum number of the inserts requested, a description of the campaign, a first requested insertion date, a second requested insertion date, the amount of the advertising budget for that campaign, the total amount of the budget used to date, who created the record, the date the record was created, who last modified the record, the date the record was last modified, a rate type identifier, a campaign status identifier, a campaign start date, a campaign end date, a media type identifier, a link to the image of the advertisement, the size of the advertisement in columns, the size in inches, a CPM, a flat rate, a percentage discount from retail, and a management system status identifier for that campaign.

A file 314 has records which includes a rate type identifier and a rate type for each rate.

An insertion date file 316 includes an insertion date identifier, the campaign identifier, the insertion date, who created the record, and the date the record was created.

A media type file 318 includes records each having a media type identifier and an associated media type name.

A file 320 is used by the system manager. It may include the manager status ID, name, and a status description. File 322 is used to store information on campaign status, including, a campaign status identification, and a campaign status name.

Campaign file 312 is a linked to an offer file 324. File 324 contains an offer identifier, a media identifier, a campaign identifier, offer status identifier, offer status date, the person providing data on offer status, who the record was created by, the date the record was created, who last modified the record, the date the record was last modified, a flat rate, a CPM rate, a percentage discount from the retail price, a reason for why the advertisement was declined, a description of why the advertisement was declined, a rate type identifier, a gross offer price, a decline date, the minimum number of insertions, and the system manager rate identification. It will be understood in not all of these days fields are always used at the same time. For example, for a given offer generally there will be a CPM or a flat rate, but not both.

The offer file is 324 is linked to an offer status file 326. Each record contains fields for offer status identification, offer status, and an offer status description. Offer file 324 is also linked to a system manager rate file 328 where each record includes a rate identifier, and the actual rate that is offered for the advertisement.

An insertion file 330 is linked to offer file 324. File 330 includes an insertion identifier, the offer identifier an insertion status identifier, an insertion status date, who created the record, the date the record was created, when the record was last modified, who last modified the record, who verified the insertion, the date the insertion was verified, the insertion acceptance rate, the number of requested insertions, the actual number of insertions, the name of the section in the newspaper where the advertisement is to be run, the page on which the advertisement is run, the insertion price, the campaign identifier, the insertion date, and a field for verification remarks.

A section file 332 is linked to insertion file 330. Each record in this file includes a newspaper section, and a description identifying the nature of that section. Insertion file 330 is also linked to an insertion status file 334. Each record in this file contains an insertion status identifier, insertion status, and an insertion status description.

A media file 336 is linked to offer file 324. This file contains information on each newspaper. The information includes the media identifier, the media name, the media type, who created the record, the date the record was created, a media status field, a media status date, who last modified the record, the date that the record was last modified, a first address for mail or packages, a second address, city, state and zip code, country, the company telephone number, a company fax telephone number, another company telephone number, the size of the daily circulation of the newspaper, the daily “open rate” for advertising, the Sunday circulation, the Sunday open rate, the CPM, the size in columns, the size in inches, a color identification field, the media company identifier, a DMA (distinct market area identifier, and a region identifier.

A color file 340 has links to campaign file 312 and media file 336. Each record in this file contains a color identifier and a corresponding color description.

The database also includes a DMA file 342. Each record therein contains a DMA identifier and a DMA name. A region file 344 contains for each record a region identifier, a region name, and a region description. These files contain information which can be accessed by the advertisers, when they log on to the system, to assist them in efficiently preparing an advertising campaign. It is also possible to have additional files that contain statistical data that has been customized to a particular field of business. Such data, updated on a regular basis, can provide accurate statistical feedback to particular advertisers. Further, a “preferred advertiser” function can be designed to bypass the newspaper selection procedure discussed above so that advertisements are sent to preselected newspapers from a customized list created by the advertiser.

It will be understood by one skilled in the art that some of the same data may appear in the same field in different files, as is the case for most relational databases. The data is stored in a file structure which, although having some duplicate entries, efficiently allows the program objects described above with respect to FIG. 1 to access and manipulate the data so that the information can be stored, retrieved and utilized to generate appropriate screens.

What is claimed is:

1. A system for placing advertisements with media organizations comprising:
an electronic database;
means for advertisers to access said database so as to place offers for an advertising campaign in said data base;
means for a media user associated with a media organization to access the database so as to review said offers;
means for said media user to accept or decline said offers;
means for placing orders for advertising specified by said campaign if an offer is accepted;
means for determining when said advertisements have been run; and
means for transferring funds from said advertisers to said media organization when said advertisements have been run.

2. The system of claim 1, further comprising means for providing an electronic message to the advertiser when said advertisements have been run.

3. The system of claim 2, wherein said message constitutes proof that said advertisements have been run.

4. The system of claim 1 further comprising means for the user at the media organization to provide a reason for why an offer for an advertisement is not accepted.

5. The system of claim 1 wherein said means for transferring funds comprises a secure network for processing credit card information.

6. The system of claim 5 wherein said secure network includes means for validating credit card information.

7. The system of claim 1 wherein said means for transferring funds utilizes an electronic check.

8. The system of claim 1 wherein said means for transferring funds utilizes an electronic wallet account.

9. The system of claim 1 wherein said means for transferring funds includes means for determining when a period of time has elapsed after the advertisements are run, and means for transferring the funds after said period has passed.

10. The system of claim 9 wherein said period of time starts after the media organization provides a message to the advertiser that an advertisement has been run.

11. The system of claim 1 wherein said database is included in a system manager further comprising a transaction server, a web browser, and a series of program objects programmed on said transaction server.

12. The system of claim 1 wherein the advertisers, the media organizations and the database are connected with a network.

13. The system of claim 11 wherein the network comprises at least one of a private network or the Internet.

14. The system of claim 11 wherein said database includes accessible distinct market area information.

15. A method for advertisers to place advertisements with media organizations through a management system having a database, said method comprising:
advertisers accessing said database so as to place offers representative of an advertising campaign in said database;
users at a media organization accessing said database so as to review said offers, and to accept or decline said offers;
generating insertion orders to insert advertisements in accordance with said campaign for offers which are accepted; and
providing payment from said advertisers to said media organization when said advertisements have been run.

16. The method of claim 15, further comprising:
generating an electronic message which provides proof that the advertisements in accordance with said insertion orders have been run; and
sending said electronic message to said advertisers

17. The method of claim 16, wherein said message constitutes proof that said advertisements have been run.

18. The method of claim 15 wherein, if an offer is declined by the user in a media organization, a reason is provided for why the offer was declined.

19. The method of claim 15 wherein said providing payment includes transferring funds using a secure network.

20. The method of claim 19, wherein payment is effected by sending credit card information using said secure network.

21. The method of claim 20 further comprising validating said credit card information.

22. The method of claim 15 wherein said providing of payment comprises utilizing an electronic check.

23. The method of claim 15 wherein said providing of payment comprises utilizing an electronic wallet account.

24. The method of claim 15 wherein said providing payment includes determining when a period of time has elapsed after the advertisements are run, and transferring funds after said period has passed.

25. The method of claim 24 wherein said period of time starts after the media organization provides a message to the advertiser that an advertisement has been run.

26. The method of claim 15 wherein said database is included in a system manager comprising a transaction server, a web browser, and a series of program objects programmed to run on said transaction server.

27. The method of claim 15 wherein the advertisers, the media organizations and the database are connected with a network.

28. The method of claim 27 wherein the network is one of a private network and the Internet.

29. The method of claim 15 wherein the database includes distinct market area information, further comprising advertisers accessing said distinct market area information.

30. The method of claim 29 wherein said advertisers use said distinct market area information to assist in planning an advertising campaign.
